(19) United States
(12) Patent Application Publication
(10) Pub. No.: US 2006/0190218 A1
(43) Pub. Date: Aug. 24, 2006

(54) Generative instrumentation framework

(76) Inventors: Subhash C. Agrawal, Boxboro, MA (US); Ian J.B. Main, Salmo (CA); Galen F. Gawboy, Lexington, MA (US); Scott M. Wimer, Fairfax, VA (US)

Correspondence Address: LAW OFFICE OF DAVID H. JUDSON, 15950 DALLAS PARKWAY, SUITE 225, DALLAS, TX, 75248, US

(21) Appl. No.: 11/062,667

(22) Filed: Feb. 22, 2005

(51) Int. Cl. G06F 11/30

(52) U.S. Cl. 702/186

(57) ABSTRACT

A generic instrumentation framework comprises two primary systems: an instrumentation generation system, and a runtime system. The instrumentation generation system creates an instrumentation generator that is specific to the system or subsystem to be instrumented. Preferably, the instrumentation generator is created by an instrumentation generation engine, which receives as input a system descriptor. The system descriptor is a set of metadata that comprise an interface specification. The instrumentation generation engine reads the system descriptor, identifies the target system, and selects an appropriate instrumentation generator. Using the system descriptor, the instrumentation generator then creates an instrumentation “package” comprising the actual instrumentation code itself (an executable) together with an instrumentation descriptor, which describes a set of one or more instrumentation points in the target system. The target system is then available to be instrumented with the instrumentation code. At an appropriate time, such as system start up, a telemetry stream adapter of the runtime system loads in and initiates the instrumentation code. A telemetry stream reader of the runtime system reads telemetry stream data provided by the telemetry stream adapter. The telemetry is then made available to an analysis module, which also receives the instrumentation descriptor to facilitate a forensic analysis of the telemetry.

### COPYRIGHT STATEMENT

This application also includes subject matter that is protected by copyright. All rights are reserved.

### BACKGROUND OF THE INVENTION

1. Technical Field

The present invention relates generally to behavioral intrusion detection systems.

2. Background of the Related Art

Ensuring system security and reliability has become increasingly difficult in today's complex, networked computing environments. Current approaches to protecting systems include repairing application and system software by constantly applying patches, upgrading protection software with new patterns and signatures, and defining complex rules and policies that attempt to define acceptable actions. Unfortunately, these approaches still leave systems vulnerable and are subject to human error, creating management nightmares and restrictions that can significantly limit system functionality.

Despite best efforts, software vulnerabilities will continue to exist. To address these concerns, new intrusion detection technologies have begun to be developed and implemented. One solution, made available by Cylant, Inc. of Lexington, Mass., takes a different approach to the problem of protecting software systems. Rather than subjecting administrators to constant upgrades and requiring them to define complex policies, these new technologies work by automatically determining what is normal and acceptable to execute on a system; they then protect the system by stopping unacceptable behaviors. To provide protection, these systems do not just look at who is using the system or what they are doing, e.g., by examining the stimuli from outside to the system; rather, the software monitors what is happening inside the system at a very fine level of detail. Such monitoring is effecting using sophisticated instrumentation technologies that provide critical data with insignificant overhead, allowing real-time measurement of execution, together with advanced modeling techniques that build a high fidelity representation of acceptable, normal behavior of a software program. Efficient, real-time analytic techniques are also used to analyze high volumes of data and to accurately determine the acceptability of execution paths. If necessary, corrective measures may be implemented.

The above-described technologies obtain data for analysis by instrumentation within the software being monitored. The art of system instrumentation is well-developed. During the development of complex mechanical devices, for example, instrumentation is often added to ensure that design specifications are met, especially as the product evolves. Complex, multi-component devices also provide instrumentation to enable failure diagnostics. In like manner, instrumentation techniques are also becoming more ubiquitous in the area of software-based monitoring and detection systems. Software systems are instrumented for a variety of purposes such as anomaly detection, troubleshooting customer issues, communicating with third party management software, providing security audit capabilities, optimizing local and distributed system performance, enabling availability monitoring, enabling reliability monitoring, and the like.

Developing software instrumentation, however, is expensive. Software systems as a whole lag behind the more mature engineering disciplines in terms of their support for instrumentation. There are several reasons for this. First, the benefits of providing instrumentation are not commonly understood by software vendors. Second, the cost is often quite high. In contrast, the cost of providing system instrumentation to meet regulatory and technical requirements in certain disciplines (e.g., the automotive or aeronautical industries) is a fairly small percentage of the cost of the overall product development cycle. In software systems, however, the cost of the developing system instrumentation is substantial, often exceeding 10% of the overall software development cost. One reason for this high cost is that software instrumentation systems are often hand-crafted. Even when use is made of third party utilities, the utilities still have to be applied on a per function basis. Many commercially important software systems are actually opaque to the developer, meaning that significant resources need to be expended to discover the instrumentation points via indirect methods. Another challenge to be addressed is that instrumentation results are platform-specific. This means that an instrumentation system developed for one platform is not applicable to another platform. Moreover, instrumentation systems that are handcrafted are often system-specific, which means that the approach has to be reinvented each time a new system is to be addressed. Unification approaches are known, but require the cost of imposing an artificial layer of abstraction, which can lead to loss of the semantic context for the underlying system.

Moreover, even when such instrumentation systems are created, the instrumentation definitions (what to instrument) are static. The software development field as a whole generally does not have a good understanding as to what needs to be instrumented, which significantly reduces the flexibility of existing solutions. As a consequence of these and other problems in the art, software vendors typically only provide instrumentation capabilities to meet their own needs, which needs may or may not be congruent with the needs of the users of their software. For example, software often ships with trace options that can be turned on by setting documented or undocumented system properties. The motivation for this latter approach is to lower a vendor's support costs. For competitive reasons, some vendors cause their software to emit performance data. While these techniques provide some elementary advantages, from the standpoint of more mature engineering fields, however, the degree and use of instrumentation techniques in software engineering is minimal.

A complex engineering system does not exist in the abstract. It is much more commonplace for what was once a standalone system to now evolve into a component of a larger system or subsystem. By its very nature, a handcrafted instrumentation implementation cannot be made aware of this embedding, at least not without significant changes. This problem can be ameliorated to some limited extent, e.g., by imposing a generic representation on the instrumentation telemetry. This cost of such an approach, however, is a loss of detail in the instrumentation data that is generated.

The present invention addresses these and other needs in the prior art.

### BRIEF SUMMARY OF THE INVENTION

The present invention provides for automatic generation of instrumentation to enable software systems to be instrumented for a wide variety of purposes such as anomaly detection, troubleshooting, communications, auditing, availability and performance monitoring, reliability monitoring, and the like.

An object of the invention is to provide a system for and method of generating context sensitive instrumentation, particularly for software systems or subsystems. In particular, given an interface definition of a system, the present invention enables the generation of an instrumentation engine that is capable of decomposing functionalities of the interface into discrete data. At runtime, this data is collected and made available for analysis.

It is a more general object of the invention to lower software development costs by utilizing known data to automate instrumentation generation for a software system.

According to an illustrated embodiment, a generic instrumentation framework comprises two primary systems: an instrumentation generation system, and a runtime system. The instrumentation generation system creates an instrumentation generator that is specific to the system or subsystem to be instrumented. Preferably, the instrumentation generator is created by an instrumentation generation engine, which receives as input a system descriptor. The system descriptor is a set of metadata that comprise an interface specification. The instrumentation generation engine reads the system descriptor, identifies the target system, and selects an appropriate instrumentation generator. Using the system descriptor, the instrumentation generator then creates an instrumentation “package” comprising the actual instrumentation code itself (an executable) together with an instrumentation descriptor, which describes a set of one or more instrumentation points in the target system. The target system is then available to be instrumented with the instrumentation code. At an appropriate time, such as system start up, a telemetry stream adapter of the runtime system loads in and initiates the instrumentation code. A telemetry stream reader of the runtime system reads telemetry stream data provided by the telemetry stream adapter. The telemetry is then made available to an analysis module, which also receives the instrumentation descriptor to facilitate a forensic analysis of the telemetry.

To create the instrumentation package, the instrumentation generator preferably first creates a core instrumentation harness that utilizes system specific capabilities to hook into appropriate places to collect relevant data about instrumentation points. The harness leverages a set of instrumentation fragment generators. In particular, a function fragment generator creates an instrumentation point for function entry. One or more parameter fragment generators create instrumentation points for specific parameters passed to the function, and a return value fragment generator creates instrumentation points corresponding to different return values. An instrumentation builder uses the fragment generator outputs to generate the actual executable that comprises the instrumentation code and the instrumentation descriptor file. Once the telemetry is collected, the instrumentation descriptor is used (e.g., by an analysis engine) to facilitate forensic analysis.

The methodology of the present invention provides automated instrumentation by decomposing a well-defined interface specification (the system descriptor) into a set of functionalities provided by the interface's methods, and then mapping the functionalities into a set of sensors. In a representative embodiment, calls to the interface generate telemetry (e.g., a binary histogram) representing the actual functionalities of the underlying system expressed.

The invention provides generative instrumentation that allows multiple systems or subsystems to be analyzed in as much detail as required. This is facilitated by the system descriptor, which is used to drive an instrumentation generator that is specific to the system or subsystem to be instrumented. The resulting instrumentation faithfully captures the state of the target system. The invention further enables cross subsystem analysis while preserving the specific characteristics of each system and subsystem.

The present invention provides a method of monitoring a target system having two or more subsystems, wherein an interface is defined between each pair of subsystems, and a set of one or more interactions expected to occur across the interface have been specified, e.g., as an interface specification. The interface specification may be embodied as system descriptor metadata that conforms to a given system descriptor schema. According to the method, an instrumentation generator is applied to the system descriptor metadata to generate a set of instrumentation, together with an instrumentation specification. According to a feature of the present invention, the instrumentation and associated specification are generated programmatically (i.e., automatically), preferably using a set of fragment generators. The fragment generators create instrumentation points, wherein an instrumentation point has an associated sensor identifier. A sensor identifier may be associated with a variety of interactions in the interface specification such as: an entry into a particular function, an exit from a particular function, an exit from a particular function with a given return value, a specific value of a parameter, or any combination thereof (e.g., a particular function with a given parameter value). The interface of the target system is then instrumented with the set of instrumentation. During a runtime operation, telemetry from the instrumented interface is received. The telemetry is then analyzed (e.g., inspected, viewed, processed, or the like) by reference to the instrumentation specification to facilitate a given task (e.g., anomaly detection, a troubleshooting function, an audit function, and a performance analysis function, a reporting function, an alerting function, or the like).

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a simplified diagram of how system descriptor metadata is processed to create an instrumentation generator of the generic instrumentation framework of the present invention;

FIG. 2 illustrates how the instrumentation generator of the generic instrumentation framework reads the system descriptor metadata and generates instrumentation and its associated documentation according to the present invention;

FIG. 3 illustrates how the instrumentation generator creates a set of instrumentation points according to the invention;

FIG. 4 illustrates the components of a representative instrumentation point;

FIG. 5 illustrates a runtime operation of the present invention wherein a telemetry stream adaptor dynamically loads subsystem instrumentation created by the instrumentation generator;

FIG. 6 illustrates how the telemetry stream is amenable to both human and machine interpretation through the use of an instrumentation descriptor;

FIG. 7 illustrates how a forensics analysis engine may be used to analyze runtime data;

FIGS. 8A-8B illustrate a representative system descriptor document type definition (DTD) for the system descriptor schema;

FIG. 9 illustrates a sample system descriptor;

FIG. 10 illustrates a representative instrumentation descriptor document type definition for the instrumentation descriptor schema; and

FIG. 11 illustrates a sample instrumentation descriptor.

### DETAILED DESCRIPTION OF AN ILLUSTRATIVE EMBODIMENT

The generic instrumentation framework (GIF) of the present invention comprises two high level pieces: an instrumentation system, and a runtime system. As will be seen, the generic instrumentation framework of the present invention enables software providers (e.g., independent software vendor (ISVs)) to instrument their software systems in an efficient, cost-effective manner.

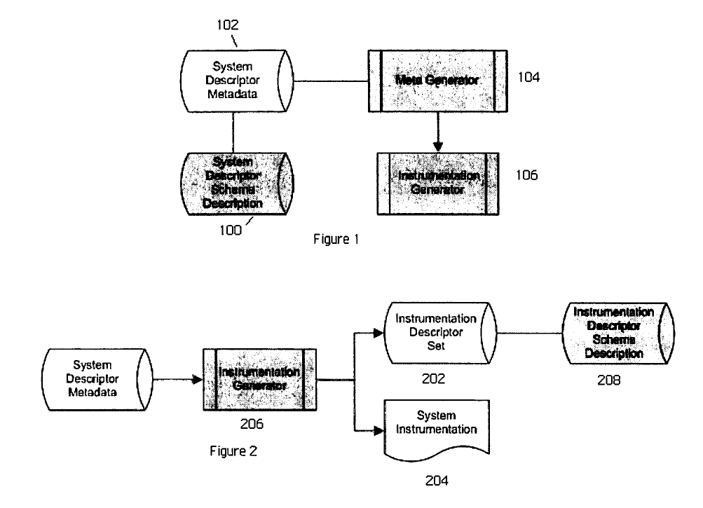

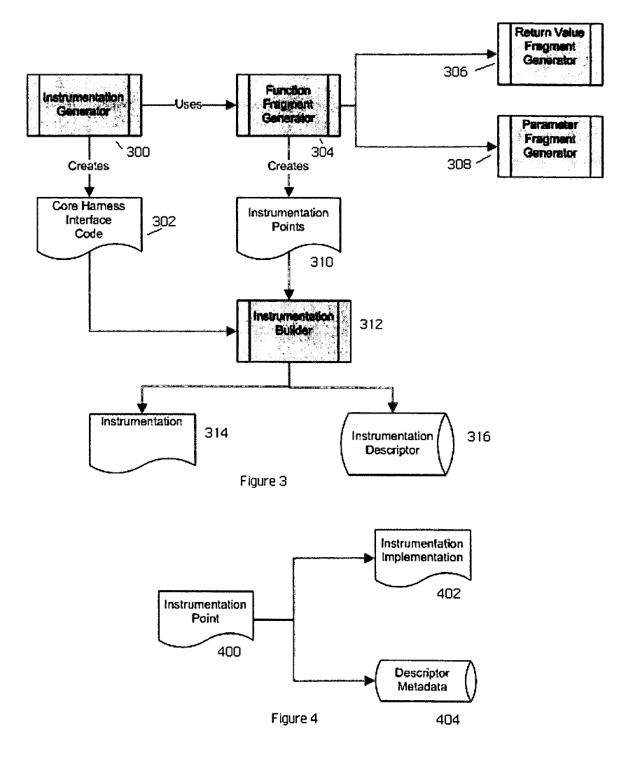

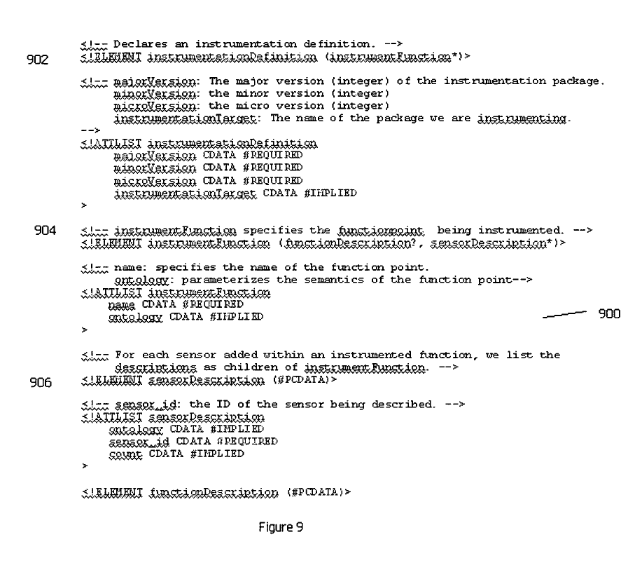

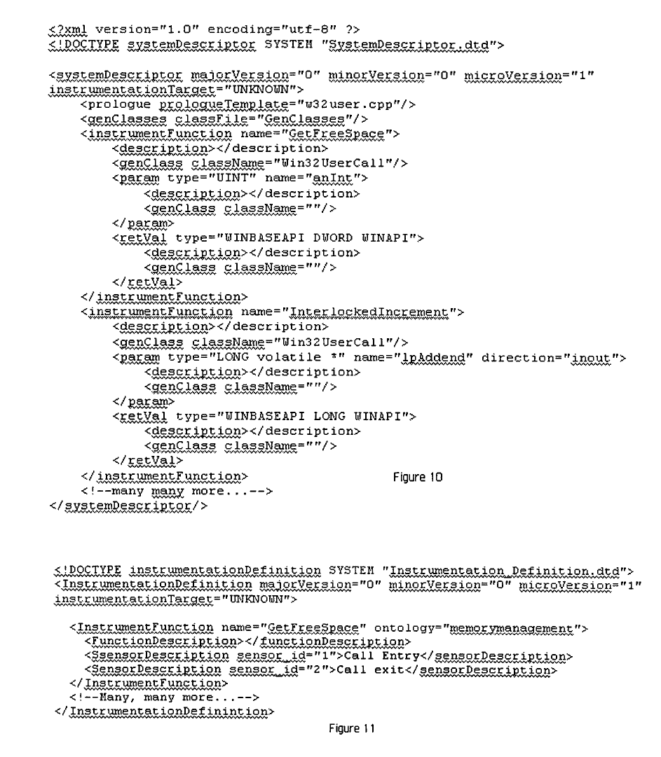

As illustrated in FIG. 1, an input to the process is a system descriptor schema description 100 and its associated system descriptor metadata 102. The system descriptor schema description conforms to a given document type definition (DTD), as illustrated in FIG. 8. The system descriptor metadata 102 typically is created by the software provider or by some other entity, such as one who is knowledgeable or expert on the native system or subsystem functions, operations and semantics. The file may be gathered programmatically, e.g., by a system aware utility authored by the domain expert. How a particular system descriptor file is authored is beyond the scope of the present invention. The system descriptor metadata conforms to the system descriptor DTD as illustrated by the representative sample shown in FIG. 9. The system descriptor schema and/or the associated system descriptor metadata comprise an interface specification. The purpose of the system descriptor is to identify what is to be instrumented. For example, in one embodiment, the system descriptor metadata 102 specifies all or some of the system calls that will be instrumented and the semantics (e.g., what arguments are to be captured, whether to instrument the return value, and so on) associated with the desired instrumentation for those system calls. Preferably, the system descriptor metadata is an XML (Extensible Markup Language) format that is supplied to a meta generator 104. The meta generator 104 reads the metadata to select an instrumentation generator 106. Both the meta generator 104 and the instrumentation generator 106 are implemented as executable code, i.e., a series of computer program instructions executable in a set of one or more processors or machines. As illustrated in FIG. 2, preferably, the instrumentation generator 206 creates an instrumentation descriptor set 202 and system instrumentation 204. The instrumentation descriptor set 202 is metadata, and the system instrumentation 204 is an object file. The instrumentation descriptor set 202 metadata conforms to an instrumentation descriptor schema description DTD 208, such as illustrated in FIG. 10. The instrumentation descriptor set 202 preferably is a file that provides a human readable description about each of a set of instrumentation points. A representative sample of the instrumentation descriptor set metadata is provided in FIG. 11. As can be seen, a given instrument point typically is assigned an identifier (sensor_id). An instrumentation point has an associated sensor identifier. A sensor identifier may be associated with an entry into a particular function, an exit from a particular function, an exit from a particular function with a given return value, a specific value of a parameter, or any combination thereof (e.g., a particular function with a given parameter value). The system instrumentation 204 is a runtime executable, typically in the form of a dynamically loadable kernel driver. As will be illustrated below, during runtime the instrumentation descriptor set 202 is used by an instrumentation interpreter (e.g., a forensic analysis engine) to analyze a stream of telemetry data that is received during runtime processing. In particular, the instrumentation descriptor set provides a map between the telemetry stream and its meaning. Thus, for example, instead of a given sensor_id (such as AfdQz), the instrumentation descriptor set would identify a function such as display sys_write called with argument ‘etc\passwd’. An ontology attribute is also maintained. Of course, the above is merely illustrative.

FIG. 3 illustrates the instrumentation generation process in more detail. The instrumentation generator 300 creates core harness interface code 302. The core harness interface code 302 allows the instrumentation to be loaded by a runtime system, as described in FIG. 5 below. Thus, for example, if the target system being instrumented is the Linux operating system, the core harness engine ensures that all functions have the appropriate linkage and the APIs called by the runtime are present and implemented correctly. In addition to creating the interface code 302, the instrumentation generator 300 generates telemetry sensors for each functional part of a given subsystem being instrumented and, if the function is driven parametrically, the generator 300 also generates those parameters as well. To this end, the instrumentation generator 300 includes a set of modules including a function fragment generator 304, a return value generator 306, and a parameter fragment generator 308. The function fragment generator 304 uses the return value fragment generator 306 and the parameter fragment generator 304 as part of the routines called by the instrumentation generator 300. The operation of these fragment generators creates in a set of instrumentation points 310 being created, and these instrumentation points are combined by an instrumentation builder 312 to create the system instrumentation 314 and its associated instrumentation descriptor 316 metadata.

FIG. 4 illustrates a representative instrumentation point 400 that is generated by the instrumentation generator of FIG. 3. As described, preferably a given instrumentation point 400 is composed of the actual instrumentation code 402 for the function point, as well as associated descriptor metadata 404.

FIG. 5 illustrates an embodiment of the runtime system of the generic instrumentation framework of the present invention. At runtime, an instrumentation runtime 500 adapts, or hooks into, the interface implementation mechanism to be able to collect, retain and provide data from interactions between components. The instrumentation runtime 500 dynamically loads the subsystem instrumentation 502 that has been created by the process described above with respect to FIG. 3. The instrumentation runtime is runnable code. In one embodiment, the instrumentation runtime is code inserted in the runtime path of control transfer between the two (in this example) subsystems the interactions between which are being measured. The insertion method to achieve this function typically is dependent on the underlying architecture of the interface implementation in the measured system. For example, if a table is used to look up the address of (or pointer to) the code to be executed as a result of a given interface transaction, the insertion method can read and preserve this target address, modify the table with the address of (or pointer to) the instrumentation point code to be executed (to thereby collect instrumentation data), and then pass control to the code that implements the actual interface transaction (e.g., the system call or function call). The instrumentation runtime also implements necessary data structures, as well as associated initialization and housekeeping functions, to retain the data collected as a result of the instrumentation. In addition, the instrumentation runtime provides collected data other components (as will be described below). The collected data may be provided periodically, upon one or more given events or occurrences, or upon demand.

In an exemplary operation, when a system or function call occurs across the interface, control gets passed to the instrumentation runtime, which then executes the instrumentation point code, and collects the desired data; control then returns to the original target of the system or function call. When the target function code finishes execution, control returns back to the instrumentation runtime's instrumentation point code, data is collected regarding the return status of the function, and control is then passed back to the point from where the original request was made. In this manner, the interface transaction can be said to be “hooked” with the instrumentation. If desired, as the instrumentation point collects data, analysis may be performed on such newly collected information, either alone or with respect to previously collected information; as a result of such analysis, a given action may be taken. This action may include further analysis, withholding further execution of the program until analysis has been completed, or even denying further execution of the target function.

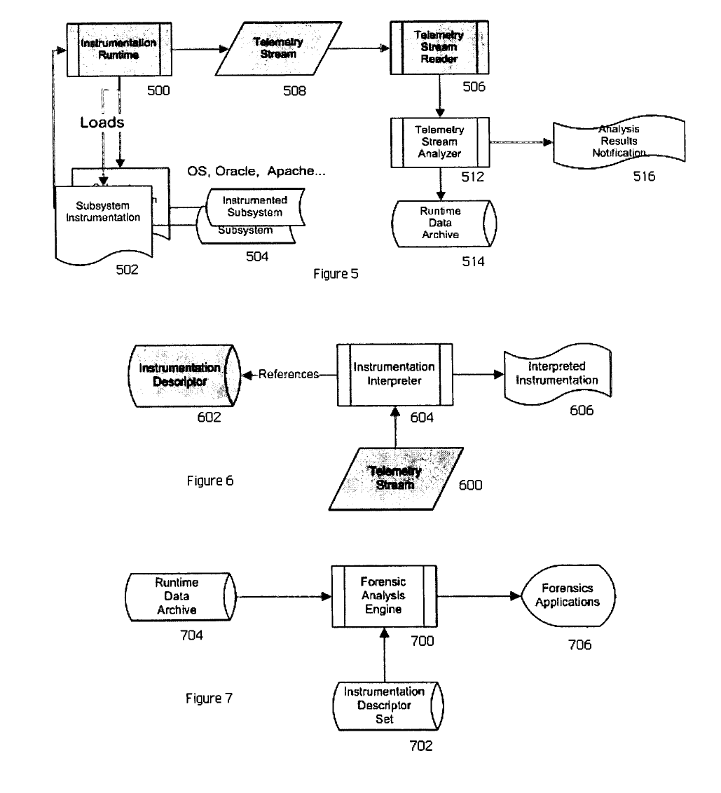

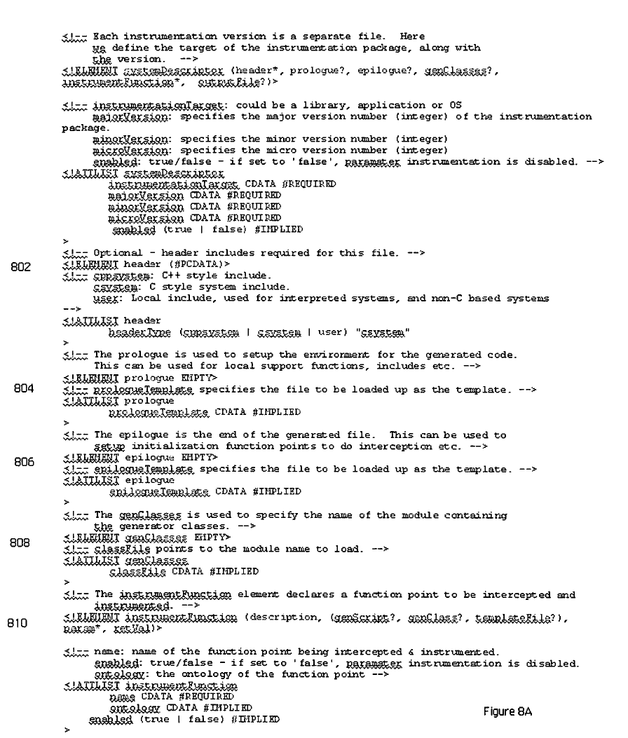

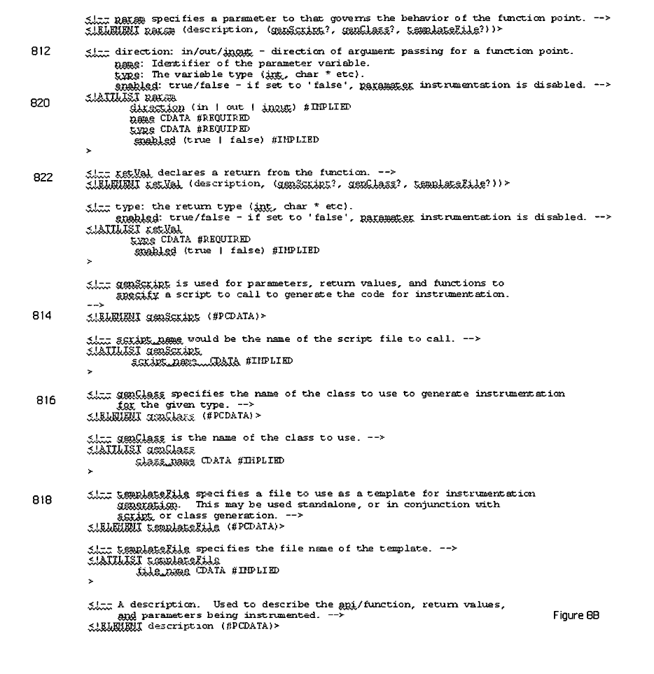

Returning to FIG. 5, a given subsystem instrumentation 502 preferably is associated with a given instrumented subsystem 504. A telemetry stream reader 506 receives the telemetry stream 508 generated by the subsystem instrumentations 502. The telemetry stream 508 is read by the telemetry stream reader 506, an executable, the output of which is provided to a telemetry stream analyzer 512. In a representative example, the telemetry stream analyzer outputs the data to the runtime data archive 514 and/or provides real-time or approximately real-time events 516, such as analysis, results and notification. As seen in FIG. 6, at runtime, the telemetry stream 600 is amenable to both human and machine interpretation through use of the instrumentation descriptor 602. In particular, an instrumentation interpreter 604 (e.g., telemetry stream analyzer 512, in FIG. 5) receives the telemetry stream 600 and references the instrumentation descriptor 602 as needed to provide the interpreted instrumentation result 606. As illustrated in FIG. 7, a more long term view of the data is available through the runtime data archive. In particular, a forensic analysis engine 700 references the instrumentation descriptor 702 to make use of the runtime data archive 704, with the results being supplied to one or more forensics applications 706. The forensic analysis engine 904 uses the ontological and system metadata from these sources to provide a forensic analysis of any data saved during the real time data gathering.

As noted above, FIG. 8 illustrates a representative system descriptor schema description, which corresponds to block 100 in FIG. 1. XML document 800 illustrates the system descriptor DTD. Preferably, each instrumentation version is a separate file. The system descriptor defines the target of the instrumentation package, along with the version. The document comprises a system descriptor element that comprises the following syntax:
><!ELEMENT systemDescriptor ((header*, prologue?, epilogue?, genClasses?, instrumentFunction*), instrumentationFile)>
The header* is shown at element 802. The prologue is shown at element 804. The prologue is used to setup the environment for the generated code. The epilogue is shown at element 806. The epilogue is the end of the generated file. The generator class is shown at element 808. It is used to specify the name of the module containing the generator classes. The instrument function is shown at element 810. This element declares a function to be intercepted and instrumented. Its syntax is shown below:
<!ELEMENT instrumentFunction (description?, (genScript?, genClass?, templateFile?), param*, retVal)>
The description element 812 is used to describe the API/function, return values and parameters being instrumented. The generator script element 814 is used to specify parameters, return values and functions to call to generate the code for instrumentation. The generator class element 816 specifies the name of the class to use to generate instrumentation for the given type. The template file element 818 specifies a file to use as a template for instrumentation generation. The parameter element 820 specifies a parameter to a function. The return value element 822 declares a return from the function. Of course, the above-described syntax for the system descriptor element is merely representative.

As noted above, FIG. 9 illustrates a representative XML document 900 for the instrumentation descriptor DTD. The descriptor has the following syntax:
<!ELEMENT instrumentationDefinition (instrumentFunction*)>
The instrumentDefinition is shown at element 902. The instrumentFunction* element 904 specifies the function being implemented and has the following syntax:
<!ELEMENT instrumentFunction (functionDescription?, sensorDescription*)>
For each sensor added within an instrumented function, the descriptions are listed as children of the instrument function. The sensor description element is shown at element 906 and comprises a set of attributes including ontology, sensor_id and count.

According to the invention, data is collected for instrumentation points that are defined according to the system descriptor. As illustrated in FIG. 5, the instrumentation points for the target system or subsystem comprise the generated instrumentation code together with the instrumented descriptor data for that code. The functions of the various modules preferably are implemented in software, e.g., as a set of computer instructions executable on a given processor or set of processors. The functions may also be implemented in firmware, or in specialized hardware. One or more of the functions, such as the telemetry stream analyzer, may be implemented from known technologies or products. The target system has been instrumented according to the present invention. In particular, the target system in this example includes a set of one or more instrumented subsystems such as operating systems, application software, databases, web servers, application servers, and the like. In FIG. 5, the target subsystems are, for example, an operating system, a database, and a web server; the telemetry stream adapter corresponds to a Linux or Windows device driver. These are merely illustrative implementations, of course. In such an implementation, the telemetry stream reader may be implemented as a given reader class. As seen in FIG. 5, the analyzer preferably implements one or more analytical algorithms. An analysis/results/notification issues alerts (or takes other given actions) with respect to potentially abnormal behaviors.

The generated telemetry data can be used for many purposes including, without limitation, runtime and/or forensic analysis of the telemetry streams. For runtime analysis, the telemetry stream reader reads the telemetry stream data. Preferably, the reader supports two modes of operation, a real time mode, and a cache mode. In the real time mode, the telemetry stream reader pushes the data to a given telemetry stream consumer or analyzer as the data is generated. In a cache mode, the telemetry stream reader saves the telemetry stream signals into a data archive and supplies a record of such data (or the data itself, or data derived therefrom) at a given request. The forensic analysis engine 904 uses the ontological and system metadata from these sources to provide a forensic analysis of any data saved during the real time data gathering.

Thus, at a high level, the present invention provides a universal system for generating context sensitive instrumentation. In particular, given an interface description (the system descriptor), an instrumentation generator is created for the purpose of decomposing the functionalities of the interface into discrete data. At runtime, this data is collected and streamed into the analyzer for real time or forensic analysis.

As illustrated in FIG. 5, the present invention facilitates inter-system analysis. Inter-system analysis includes the analysis of boundary interactions as well as system interactions. The generic instrumentation framework enables the user to create an instrumentation package that is defined for system and subsystem boundaries without losing the specificity of the system. For example, an operating system may be instrumented separately from another subsystem, with the instrumentation package then tuned for the subsystem/OS interactions. Furthermore, with the generic instrumentation framework, the most effective form of instrumentation for the boundary may be readily selected.

XML and Code Example

The following is a representative example of a portion of a system descriptor for an instrumentation target, namely, the Linux 2.4 operating system kernel:

```
<?xml version=“1.0”?>
<!DOCTYPE systemDescriptor SYSTEM “../../../../
tools/System_Descriptor.dtd”>
<systemDescriptor version=“v0” instrumentationTarget=“linux-2.4”>
  <prologue prologueTemplate=“../prologue.c”/>
  <epilogue epilogueTemplate=“../epilogue.c”/>
  <genClasses classFile=“GenClasses”/>
  <instrumentFunction name=“sys_unlink”>
    <description>System call to delete a file.</description>
    <genClass class_name=“Syscall”/>
    <param type=“const char *” name=“pathname”>
      <description></description>
      <genClass class_name=“”/>
    </param>
    <retVal type=“asmlinkage long”>
      <genClass class_name=“ErrnoReturn”/>
      <description>Errno return from system call.</description>
    </retVal>
  </instrumentFunction>
  <instrumentFunction name=“sys_setuid”>
    <description>System call to set the user ID of a process.</
    description>
    <genClass class_name=“Syscall”/>
    <param type=“uid_t” name=“uid”>
      <description></description>
      <genClass class_name=“”/>
    </param>
    <retVal type=“asmlinkage long”>
      <description>Errno return value from system call.</description>
      <genClass class_name=“ErrnoReturn”/>
    </retVal>
  </instrumentFunction>
    ....
```

To take an example, the first instrument function is “sys_unlink” that describes a system call to delete a file. In this particular example, the system descriptor instructs the generation system not to generate signals for the class name but that a signal should be generated for all possible return values. This attributes of each system descriptor element are used to select the instrumentation generator (linux-2.4, in this example). Once the instrumentation generator has been selected, it processes the elements of each instrumentation function specified. The system preferably supplies several categories of functions. In this particular example, the system descriptor tells the instrumentation generator to select the linux-2.4 version 1.30 of the Syscall generator for this function. The descriptor also tells the instrumentation generator to use a default generator for a const char* argument. It also indicates that a specific generator is to be used to deal with all possible values of the return value. As a result, the instrumentation generator (i) creates an instrumentation point and places that point in an runtime-accessible instrumentation registry, (ii) adds the function to the instrumentation implementation (in the form of executable code), and (iii) creates an instrumentation descriptor for this system descriptor element. Each of these outputs will now be described in more detail with respect to the example.

As described above, the instrumentation runtime of the runtime system loads in and initiates the instrumentation code. The telemetry stream reader of the runtime system reads telemetry stream data provided by the telemetry stream adapter. The telemetry is then made available to an analysis module, which (in one embodiment) also receives the instrumentation descriptor to facilitate a forensic analysis of the telemetry.

In particular, the instrumentation registry typically is system specific. For the Linux-2.4 system call example above, the registry entry is an index in a hook table, i.e.:
static asmlinkage long (*original_sys_unlink) (const char * pathname).

The instrumentation implementation, as noted above, refers to the actual instrumentation. An italicized portion below indicates what was generated for the “path” argument. The bold portion is what the ERRnoReturn fragment generator creates. The italicized portion shows the default way that char* arguments are handled. In this example, a range of sensors is assigned for each string. These sensors correspond to different hashes that the string may have his hashing and signal assignment is done by the resolve_target_path and kp_intercept_click_path methods. The bold section shows one of the ways that return values are generated. In this case, the generator returns a signal for success and failure. The original function is then invoked, and then the return value is checked, and the generated sensor id is sent to the stream.

```
static asmlinkage long
kp_sys_unlink (const char * pathname)
{
    int retval;
    kp_hook_instr_pid (1);
  do {
        char *parh; /*See paragraph 2 of section 2.2 for a detailed
        explanation*/
        int valid;
        unsigned short len;
        resolve_target_path (pathname, &path, &len, &valid);
        kp_intercept_click_path (path, 2);
        if (path) {
          rchunk_free (path, len);
        }
      } while (0);
    retval = original_sys_unlink (pathname);
    if (retval == 0) /*paragraph 3 of section 2.2*/
          kp_hook_instr_pid (53);
    else
          kp_hook_instr_pid (54);
    return (retval);
}
```

The instrumentation descriptor documents the meaning of all the signals that are created. This is useful for both human and machine interpretation. The following represents the instrumentation descriptor for the above-described system call example:

```
<instrumentationDefinition instrumentationTarget=“linux-2.4”
            majorVersion=“1” minorVersion=“3” microVersion=“0”>
  <instrumentFunction name=“sys_unlink”>
    <functionDescription>System call to delete a file.</
    functionDescription>
    <sensorDescription ontology=“ENTRY” sensor_id=“1”>System
    call entry.</sensorDescription>
    <sensorDescription ontology=“ARG” sensor_id=“2” count=
    “51”>Pathname argument.</sensorDescription>
    <sensorDescription ontology=“RET_NORM” sensor_id=“53”>Good
    return value from system
call.</sensorDescription>
    <sensorDescription ontology=“RET_ERR” sensor_id=“54”>Bad
    return value from system
call.</sensorDescription>
  </instrumentFunction>
```

More generally, the present invention provides a method of monitoring a target system having two or more subsystems, wherein an interface is defined between each pair of subsystems, and a set of one or more interactions expected to occur across the interface have been specified, e.g., as an interface specification. A representative target system is a web server system that has a first subsystem (e.g., an operating system such as Linux) and a second subsystem (e.g., a Web server such as Apache). An interface exists between the subsystems. In this example, the interface is a set of system calls that are defined or specified in an interface specification, preferably as system descriptor metadata that conforms to a system description schema DTD, as has been described above. According to the invention, the interface between a set of subsystems is instrumented with programmatically generated instrumentation having an associated instrumentation description. The “interface” is not limited to a set of system calls, however. The term should be broadly construed to mean any interface between machine and machine, process and machine, human and machine, or the like. Thus, according to the invention an instrumented interface could be quite varied, such as system call interface, a Web service, a command line interface (CLI), or any other known or later developed construct over which first and second subsystems interact. According to the method, an instrumentation generator is applied to the system descriptor metadata to generate a set of instrumentation, together with an instrumentation specification. The instrumentation and associated specification are generated programmatically (i.e., automatically), preferably using a set of fragment generators. The fragment generators create instrumentation points, wherein an instrumentation point has an associated sensor identifier. As has been described, a sensor identifier may be associated with a variety of interactions in the interface specification such as: an entry into a particular function, an exit from a particular function, an exit from a particular function with a given return value, a specific value of a parameter, or any combination thereof (e.g., a particular function with a given parameter value). The interface of the target system is instrumented with the set of instrumentation in any convenient manner. The instrumentation may be implemented on a provider side of the interface, on a requestor side of the interface, or on both sides of the interface. During a runtime operation, telemetry from the instrumented interface is received. The telemetry is then analyzed (e.g., inspected, viewed, processed, or the like) by reference to the instrumentation specification to facilitate a given task (e.g., anomaly detection, a troubleshooting function, an audit function, and a performance analysis function, a reporting function, an alerting function, or the like).

The present invention has numerous advantages over the prior art. The invention provides for generation of instrumentation for an interface given a description of the interface. This allows rapid development of instrumentation for a given software system. Changes to the software system can be addressed easily by changing the interface description and regenerating the instrumentation.

The described approach is platform and subsystem generic. In particular, by performing instrumentation on the interface between systems, the instrumentation data is created based on use of the system, rather than the details of the implementation. This generates data that is platform and subsystem generic.

The invention provides generative instrumentation that allows multiple systems to be analyzed in as much detail as required. This is accomplished by using the system descriptor file to generate system descriptors. The resulting instrumentation faithfully captures the state of the system. The invention further enables cross subsystem analysis while preserving the specific characteristics of each system and subsystem via these mechanisms. In addition, the present invention preserves the specific characteristics of each system and subsystem being instrumented.

Unlike some of the prior art, the invention does not attempt to unify and generalize disparate systems so the potential for information loss is greatly reduced. This compartmentalization allows for the right analytical model to be applied to each subsystem, providing superior results. In addition, the described approach is not limited to a specific platform or subsystem. This advantage is achieved by creating system specific instrumentation, preferably in a system independent format, and by communicating via a preferably neutral telemetry data format. In particular, this benefit is provided by the stream format, which is preferably semantically platform-neutral. This means that there is no system dependent information embedded in the manner in which data stream is encoded. Stream semantics preferably are encapsulated by stream metadata. This decoupling facilitates system specific accuracy via a system independent, platform neutral approach. A beneficial byproduct of this approach is that an optimal analysis algorithm can be applied to any system or subsystem.

The present invention is also capable of generating, loading and running instrumentation from a variety of sources. This enables inter-system and inter-subsystem analysis, given the appropriate analysis specification and analytics engines.

The present invention is applicable to a variety of system types including, without limitation, operating systems, distributed objects, RPC, Java, NET, XML RPC, XML SOAP, D Language, hardware generated data, SQL analysis, transaction servers and other computer systems. In addition to software systems, the techniques of the present invention may also be used to process telemetry from other sources, such as other physical systems, satellite data, and the like. In particular, even though this telemetry data is often the instrumentation data for these latter systems, the present invention provides the ability to analyze the interactions with other systems for which external instrumentation must be applied.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the present invention has been described in the context of a method or process, the present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. A given implementation of the present invention is software written in a given programming language that runs on a standard hardware platform running an operating system.

While given components of the system have been described separately, one of ordinary skill will appreciate that some of the functions may be combined or shared in given instructions, program sequences, code portions, and the like.

Having described our invention, what we now claim is as follows.

1. A method of monitoring a target system having two or more subsystems, wherein an interface is defined between each pair of subsystems, and a set of one or more interactions expected to occur across the interface have been specified as an interface specification, comprising:
applying an instrumentation generator to the interface specification to programmatically generate at least one instrumentation points, together with an instrumentation specification;
at runtime, loading the set of one or more instrumentation points; and
monitoring one or more interactions across the interface as the target system executes using the set of one or more instrumentation points.

2. The method as described in claim 1 further including:
receiving telemetry from a given instrumentation point; and
analyzing the telemetry using the instrumentation specification.

3. The method as described in claim 1 wherein the step of monitoring one or more interactions across the interface uses an instrumentation point to record given data.

4. The method as described in claim 3 further including the step of analyzing the given data and taking a given action as a result of the analysis.

5. The method as described in claim 4 wherein the given action suspends further execution of a given interaction until a subsequent analysis of at least the given data is completed.

6. The method as described in claim 1 wherein during a given interaction, process control is passed to a given instrumentation point, which then executes to collect given data.

7. The method as described in claim 6 further including the step of returning process control from the given instrumentation point to a target of the given interaction.

8. The method as described in claim 1 wherein the pair of subsystems comprises a first subsystem and a second subsystem, and the interaction is a system call or a function call.

9. The method as described in claim 2 wherein the interface specification includes at least one system description element that describes a given system call function being instrumented, the system description element comprising return values and parameters for the system call being instrumented.

10. The method as described in claim 1 wherein applying the instrumentation generator to the interface specification maps a given function being instrumented into the set of one or more instrumentation points.

11. The method as described in claim 2 wherein the telemetry is analyzed upon a given interaction across the interface, upon multiple interactions across the interface, or by inspecting a data archive of interactions.

12. The method as described in claim 1 wherein the interface specification defines a set of functions provided by methods of at least one subsystem.

13. A method of monitoring a target system having two or more subsystems, wherein an interface is defined between each pair of subsystems, and a set of one or more interactions expected to occur across the interface have been specified as an interface specification, comprising:
applying an instrumentation generator to the interface specification to programmatically generate a set of instrumentation;
instrumenting the interface of the target system with the set of instrumentation; and
during a runtime operation, receiving telemetry from the target system that is output from the set of instrumentation; and
analyzing the telemetry to provide a given monitoring function selected from: an anomaly detection function, a troubleshooting function, an audit function, and a performance analysis function, a reporting function, and an alerting function.

14. The method of monitoring as described in claim 13 wherein applying the instrumentation generator to the interface specification maps a given function being instrumented into a set of one or more instrumentation points.

15. The method of monitoring as described in claim 13 wherein a given system call to a target system interface generates telemetry associated with one or more underlying functions of the target system.

16. The method of monitoring as described in claim 13 wherein the telemetry represents measurement data generated upon transfer of control between the subsystems of the target system.

17. A method of monitoring a target system having two or more subsystems, wherein an interface is defined between each pair of subsystems, and a set of one or more interactions expected to occur across the interface have been specified as an interface specification, comprising:
applying an instrumentation generator to the interface specification to programmatically generate a set of instrumentation;
at runtime, loading the set of instrumentation; and
monitoring one or more system or functions calls across the interface as the target system executes; and
receiving telemetry from the set of instrumentation as the system or function calls are executed.

18. The method of monitoring as described in claim 17 wherein applying the instrumentation generator to the interface specification maps a given function being instrumented into a set of one or more instrumentation points.

19. The method as described in claim 17 wherein applying the instrumentation generator creates an instrumentation point for entry to a given function.

20. The method as described in claim 17 wherein applying the instrumentation generator creates an instrumentation point for a given parameter expected to be passed to the given function.

21. The method as described in claim 17 wherein applying the instrumentation generator creates an instrumentation point for a given return value expected to be returned from the given function.
